(19) United States
(12) Patent Application Publication
(10) Pub. No.: US 2022/0016816 A1
(43) Pub. Date: Jan. 20, 2022

(54) METHOD FOR PRODUCING VIRTUAL THREE-DEMENSIONAL PATTERNS IN MOLDED BODIES MADE OF PLASTIC

(71) Applicant: MERCK PATENT GMBH, DARMSTADT (DE)

(72) Inventors: Marc HUNGER, Viernheim (DE); Laurent DELOUX, Heidelberg (DE)

(73) Assignee: MERCK PATENT GMBH, DARMSTADT (DE)

(21) Appl. No.: 17/299,742

(22) PCT Filed: Dec. 2, 2019
(86) PCT No.: PCT/EP2019/083208

§ 371 Date: Jun. 3, 2021

(30) Foreign Application Priority Data
Dec. 4, 2018 (EP) 18210091.7

(51) Int. Cl. B29C 45/14; B29C 45/37; B29C 45/16; B29C 67/24

(52) U.S. Cl. CPC B29C 45/14688; B29C 45/372; B29K 2101/12; B29C 67/246; B29C 45/1671

(57) ABSTRACT

The present invention relates to a two-step process for the production of virtual three-dimensional patterns in polymeric mouldings with the aid of injection-moulding processes, in particular a process in which a conventional injection-moulding process are combined with a reactive injection-moulding process in a suitable manner in order to obtain polymeric mouldings having a virtual three-dimensional pattern which is visible on one surface and is formed by flake-form effect pigments, and to the polymeric mouldings produced by means of this process and to the use thereof, in particular for decorative purposes.

The present invention relates to a two-step process for the production of virtual three-dimensional patterns in polymeric mouldings with the aid of injection-moulding processes, in particular a process in which a conventional injection-moulding process and a reactive injection-moulding process are employed in a suitable manner in order to obtain polymeric mouldings having a virtual three-dimensional pattern which is formed by flake-form effect pigments, and to the polymeric mouldings produced by means of this process and to the use thereof.

Decorative three-dimensional patterns on plastic articles are known and have already been in use for some time. They provide the said goods with an exclusive appearance which suggests depth and differs from conventional patternings in an advantageous manner. The mouldings or films are frequently embossed or otherwise structured on at least one of their surfaces in order ultimately to have a three-dimensional pattern. In order to achieve particular optical effects, both mouldings and also films are often assembled in multiple layers and embossed in the layer composite. In addition, they may also be provided with functional and/or decorative coatings, usually in the form of paints, which may optionally also comprise metal-effect pigments and the like, in order, for example, to increase the gloss of the three-dimensional structures.

Structuring processes of this type are often associated with high equipment complexity. Three-dimensionally embossed surfaces of polymeric mouldings additionally have the disadvantage that they are susceptible to dirt and can only be protected inadequately against mechanical deformations.

Various processes have therefore already been developed with the aid of which polymeric mouldings, which are generally films, can be provided with three-dimensional patterns in such a way that although these patterns are visually perceptible to the observer, they are not haptically perceptible.

Thus, for example, JP-A-07-137221 and JP-A-05-092538 disclose decorative layer systems which in each case contain embossed or otherwise structured layers, which may also comprise lustre pigments, usually applied via printing inks, between a polymeric substrate and a polymeric top layer. The production of composite materials of this type requires a multiplicity of different working steps and complex lamination or other bonding of different material layers to one another. In addition, only flat, i.e. substantially two-dimensional mouldings, such as, for example, decorative films, can be produced in this way, while mouldings having a distinctly three-dimensional shape cannot be produced.

DE 10 2004 041 833 A1 discloses a process for the production of a decorated injection-moulded article, in which a transfer film which contains a decorative element which is located on a support film provided with a release layer is coated with a plastic injection-moulding composition on the side facing away from the support film in an injection mould, the support film is subsequently detached, and the moulding prefabricated in this way is likewise coated with an injection-moulding composition on the transfer film side in a second injection mould. The resultant polymeric moulding contains in the interior the transfer film's transfer layer carrying the decoration. The decoration can be holograms or diffractive structures, which remain un-changed during the two injection-moulding steps and are visible on both sides in the resultant polymeric moulding.

Although this process gives rise to optically attractive polymeric mouldings having patterns which cannot be felt haptically and in which the patterns may have three-dimensional shapes, a process of this type can only be implemented with high equipment complexity and material costs. Thus, multilayered transfer films with pattern interlayers produced in a complex manner firstly have to be prefabricated and subsequently have to be coated successively on both sides by means of two different injection moulds. A process of this type is much too complex for the production of mass-produced articles and therefore cannot be employed economically.

EP 2960039 A1 discloses an injection-moulding process for the generation of three-dimensional patterns in plastic mouldings in which a thermoplastic film which is pigmented with effect pigments is provided on its back with a three-dimensional pattern in an injection mould and at the same time is coated on its front with a thermoplastic composition. Plastic mouldings are obtained which, through the thermoplastic composition, have a readily visible three-dimensional pattern. However, thermoplastic surfaces are of only limited suitability for applications which require high durability and/or scratch resistance.

It would therefore be desirable to have available a comparatively simple, fast and inexpensive production process which is suitable for the production of polymeric mouldings from thermoplastic base mouldings having a mechanically stable polymeric surface layer comprising a material which is different to that of the base moulding, where the polymeric mouldings exhibit, on viewing of their polymeric surface layer, an optically, but not haptically, perceptible pattern with a three-dimensional appearance and the polymeric surface layer is distinguished by high resistance to environmental influences and/or high scratch resistance, where the process can be carried out with comparatively few process steps and with conventional moulds, good adhesion of thermoplastic base moulding and polymeric surface layer is ensured, and where the pattern is an attractive, glossy pattern with a three-dimensional appearance in the interior of the moulding, and mouldings produced in this way.

The object of the present invention therefore consists in providing a process which allows the production of glossy patterns having a three-dimensional appearance with fine line structures in the interior of two- or three-dimensionally shaped polymeric mouldings which are composed of at least two parts made from different polymeric plastics which are strongly bonded to one another and have a mechanically stable, optically attractive surface, in comparatively few working steps by means of moulding processes and apparatuses known per se.

A further object of the present invention consists in providing two- or three-dimensional polymeric mouldings which, on viewing of at least one of their surfaces, exhibit a glossy pattern having a three-dimensional appearance with fine line structures which is located in the interior of the moulding, without having an equally three-dimensional pattern on their mechanically stable surface, where the mouldings consist of at least two parts made from different polymeric plastics which are inseparably bonded to one another and have no weld lines.

An additional object of the present invention consists in indicating the use of the polymeric mouldings produced in this way.

The object of the present invention is achieved by a reactive injection-moulding process for the generation of virtual three-dimensional patterns in mouldings, where
in a first process step
   in an injection mould which has injection-mould parts A and B which can be separated from one another and which have an inside surface A′ and B′ respectively and together form an interior cavity, where inside surface A′ has bumps and/or pits on a base area which form a three-dimensional pattern, with the injection mould opened
   a thermoplastic film pigmented with flake-form effect pigments is fixed to surface A′,
   the injection mould is closed,
   a thermoplastic melt is introduced into the interior cavity between the thermoplastic film and surface B′ of injection mould part B,
   and the injection mould is heated or cooled with formation of a polymeric base moulding, where the base moulding has a body comprising a thermoplastic and a surface comprising the thermoplastic film which has a three-dimensional pattern comprising bumps and/or pits which is virtually enhanced by alignment of the flake-form effect pigments parallel to the bumps and/or pits in the thermoplastic film, and where
in a second process step
   the polymeric base moulding is introduced into an injection mould having an interior cavity in such a way that the base moulding's outside surface which has the thermoplastic film with bumps and/or pits faces the interior cavity,
   the injection mould is closed, and
   a mixture of at least two flowable components which react with one another with polymerisation is introduced into the interior cavity remaining, at least partly flooding the thermoplastic film, where the flowable components solidify with one another by polymerisation to form a transparent plastic and the thermoplastic film forms a strong and positive bond to this plastic, and
   the injection mould is heated or cooled and subsequently
   the resultant moulding, which has an outside surface comprising the transparent plastic and a virtual three-dimensional pattern formed by the flake-form effect pigments on at least part of this outside surface, is demoulded or removed.

Furthermore, the object of the invention is achieved by a polymeric moulding which has a thermoplastic base moulding and a transparent surface layer located thereon comprising a transparent plastic formed by reactive polymerisation of at least two flowable components, where the thermoplastic base moulding and the transparent surface layer have an interface with one another which is formed by a thermoplastic film pigmented with flake-form effect pigments which has a film surface which faces the transparent surface of the polymeric moulding and has a three-dimensional pattern comprising bumps and/or pits which is virtually enhanced by alignment of the flake-form effect pigments parallel to the bumps and/or pits in the thermoplastic film and is visible through the transparent surface layer, produced by the process described above.

In addition, the object of the invention is also achieved by the use of the moulding described above as decorative and/or labelling element or part of durable consumer goods.

The present invention therefore relates to a two-step injection-moulding process for the production of a two- or three-dimensionally shaped polymeric moulding which has no weld lines and in which a glossy pattern having a three-dimensional appearance is visible at least on part of its outside surface and is not present in the same way in a spatially three-dimensional manner on this part of the surface, i.e. represents a virtual three-dimensional pattern, and in which the outside surface has high resistance to environmental influences and/or high scratch resistance and has a material composition which is different from the polymeric base moulding.

The injection-moulding process according to the invention is composed of two part-steps, which, taken individually, are known per se, but are advantageously combined with one another.

The first process step corresponds substantially to the process in accordance with EP 2960039 A1, in which a thermoplastic film pigmented with flake-form effect pigments is simultaneously three-dimensionally shaped on the back film surface and coated on the opposite film surface with a thermoplastic composition in an injection-moulding device whose first inside surface A′ has been provided with a three-dimensional pattern. Temporary fixing of the film to the inside surface A′ can be carried out, for example, by application of a vacuum, electrostatically, via spot adhesive points which can easily be detached on exposure to elevated temperatures, or other suitable, temporary fixing measures, such as, for example, clamps or frames. In this process, polymeric plastic bodies are obtained whose back A″ has a three-dimensional pattern which becomes visible from the transparent front side B″, which is formed by the thermoplastic composition. In order to ensure good visibility of the three-dimensional pattern, which is optically enhanced by the effect pigments, the thickness of the layer formed by the thermoplastic composition is necessarily limited. In addition, it should have high transparency, i.e. should preferably not be pigmented with particulate colourants.

In a first process step of the injection-moulding process according to the invention, by contrast, the front side, i.e. the visible side, of a thermoplastic film pigmented with flake-form effect pigments is provided with a three-dimensional pattern comprising bumps and/or pits and at the same time the body of a base moulding is formed by introduction of the thermoplastic melt and is bonded to the thermoplastic film to form the polymeric base moulding.

After the thermoplastic film pigmented with the flake-form effect pigments has been fixed to the inside surface A′ of the injection mould, the injection mould is closed and a thermoplastic melt is introduced into the cavity remaining between the thermoplastic film and surface B′ of the injection mould. After the introduction of the plastic melt into the cavity, the latter is completely filled by the plastic melt. The introduction of the transparent plastic melt into the cavity of the injection mould is preferably carried out under increased pressure and at elevated temperature, in each case depending on the materials used. The temperature of the plastic melt here is at least as high as the glass transition temperature TG of the plastic component of the thermoplastic film and is preferably above this. Due to the action of the hot plastic melt and the pressure that the molten transparent plastic composition exerts on the pigmented thermoplastic film during the introduction into the cavity of the injection mould, the thermoplastic film reaches a temperature which allows mechanical deformation of the film. The specific working temperature in each case depends on the processed plastics and is usually in the range from 120° C. to 400° C., preferably from 200° C. to 280° C. The pressure employed in the process during the introduction of the thermoplastic melt into the cavity of the injection mould is also in each case machine- and material-dependent and is usually in the range from 100 to 2500 bar (1×10⁷ N/m² to 2.5×10⁸ N/m²).

Suitable as polymeric plastic material for the thermoplastic film are conventional thermoplastic materials, such as, for example, polystyrene (PS), polystyrene blends, styrene-acrylonitrile (SAN), acrylate-styrene-acrylonitrile (ASA), polycarbonate (PC), polymethyl methacrylate (PMMA), acrylonitrile-butadiene-styrene (ABS) and ABS/PC blends, polyamide (PA) or polyester (PE). It is also possible to employ further copolymers, other than those mentioned above, which contain the above-mentioned polymers.

In accordance with the invention, the films formed from the thermoplastic materials are pigmented with flake-form effect pigments. In accordance with the invention, the pigmentation of the thermoplastic film is carried out via mass colouring of the film. This means that flake-form effect pigments in suitable form and amount are added to the polymeric plastics as early as during production of the film and are converted into films together with the plastics, which is generally carried out by extrusion. This can be carried out by direct addition of flake-form effect pigments to plastic granules or also by the preparation of compounds comprising effect pigments or through masterbatches with subsequent joint granulation. Due to the shear forces acting there, the extrusion process per se already leads to substantially parallel alignment of the flake-form effect pigments relative to the surface of the pigmented film formed. Such a parallel alignment of the flake-form effect pigments can be enhanced further by subsequent stretching of the film.

Combined pigmentation of the film with the aid of mass colouring and an additional printing or coating process is also possible.

The pigmented thermoplastic film employed in accordance with the invention comprises the flake-form effect pigments in an amount of 0.1 to 20% by weight, based on the total weight of the pigmented film. Proportions of 0.5 to 5% by weight are particularly preferred here.

In addition to the flake-form effect pigments, the pigmented thermoplastic film may also comprise further inorganic or organic coloured pigments, dyes and/or fillers. The conventional colourants and fillers generally employed for the colouring of plastic films or printing inks or coating compositions are suitable here so long as they do not permanently obstruct the optical effects achieved by the flake-form effect pigments.

The flake-form effect pigments employed in the process in accordance with the present invention can be all known flake-form effect pigments so long as they are visible in the thermoplastic film. Flake-form effect pigments of this type are advantageously selected from the group pearlescent pigments, interference pigments, metal-effect pigments, flake-form functional pigments, flake-form structured pigments, or a mixture thereof.

These effect pigments are built up from one or more layers of different materials and are in flake form.

These pigments preferably have a flake-form support on which one or more layers are located, where at least the support and the layer located directly on the support and/or at least two respectively adjacent layers of the coating differ from one another in their refractive indices n at least by the value Δn=0.1. The layers located on the support here are preferably metals, metal oxides, metal oxide hydrates or mixtures thereof, mixed metal oxides, suboxides, oxynitrides, metal fluorides or polymer materials.

Pearlescent pigments consist of transparent flakes of high refractive index and exhibit a characteristic pearlescence due to multiple reflection in the case of parallel alignment. Pearlescent pigments of this type which additionally also exhibit interference colours are known as interference pigments.

Although classical pearlescent pigments, such as TiO₂ flakes, basic lead carbonate, BiOCl pigments or nacreous pigments, are naturally also suitable in principle, the effect pigments employed for the purposes of the invention are preferably flake-form interference pigments or metal-effect pigments which have at least one coating of a metal, metal oxide, metal oxide hydrate or mixtures thereof, a mixed metal oxide, metal suboxide, metal oxynitride, metal fluoride or a polymer on a flake-form support.

The term metal-effect pigments denotes effect pigments which have at least one metal support or metal coating.

The flake-form support of the effect pigments employed preferably consists of natural or synthetic mica, kaolin or another phyllosilicate, glass, calcium aluminium borosilicate, SiO₂, TiO₂, Al₂O₃, Fe₂O₃, polymer flakes, graphite flakes or metal flakes, such as, for example, of aluminium, titanium, bronze, silver, copper, gold, steel or diverse metal alloys.

Particular preference is given to flake-form supports comprising mica, glass, calcium aluminium borosilicate, graphite, SiO₂, Al₂O₃ or aluminium.

The size of the flake-form support particles is not crucial per se, but the flake-form effect pigments must be visible in the thermoplastic film and be capable of being oriented in the film. The support particles generally have a thickness between 0.01 and 5 μm, in particular between 0.05 and 4.5 μm and particularly preferably from 0.1 to 1 μm. The length or width dimension is usually from 5 to 250 μm, preferably from 5 to 100 μm and in particular from 5 to 125 μm. They generally have an aspect ratio (ratio of average diameter to average particle thickness) of at least 2:1, preferably of from 3:1 to 500:1 and in particular from 6:1 to 250:1.

The said dimensions for the flake-form supports also apply in principle to the coated effect pigments used in accordance with the invention, since the additional coatings are generally in the region of only a few hundred nanometres and thus do not significantly influence the thickness or length or width (particle size) or thickness of the pigments.

In the case of the flake-form effect pigments employed in accordance with the invention, a coating applied to the support preferably consists of metals, metal oxides, mixed metal oxides, metal suboxides or metal fluorides and in particular of a colourless or coloured metal oxide selected from TiO₂, titanium suboxides, titanium oxynitrides, Fe₂O₃, Fe₃O₄, SnO₂, Sb₂O₃, SiO₂, Al₂O₃, ZrO₂, B₂O₃, Cr₂O₃, ZnO, CuO, NiO or mixtures thereof.

Coatings of metals are preferably of aluminium, titanium, chromium, nickel, silver, zinc, molybdenum, tantalum, tungsten, palladium, copper, gold, platinum or alloys comprising these. The metal fluoride employed is preferably MgF2.

Particular preference is given to effect pigments which have a flake-form support comprising mica, glass, calcium aluminium borosilicate, graphite, SiO₂, Al₂O₃ or aluminium and at least one layer on the support selected from TiO₂, titanium suboxides, titanium oxynitrides, Fe₂O₃, Fe₃O₄, SnO₂, Sb₂O₃, SiO₂, Al₂O₃, MgF₂, ZrO₂, B₂O₃, Cr₂O₃, ZnO, CuO, NiO or mixtures thereof.

The effect pigments can have a multilayered structure in which a plurality of layers, which preferably consist of the above-mentioned materials and have different refractive indices, are located one above the other on a metallic or non-metallic support in such a way that in each case at least two layers of different refractive index are located alternately on the support, where the refractive indices in the individual layers differ from one another by at least 0.1 and preferably by at least 0.3. The layers located on the support here may be either colourless or coloured, predominantly transparent, semi-transparent or even opaque.

Depending on the substrate material used and the type of layers applied, the effect pigments obtained are therefore also colourless or have a mass tone, or are predominantly transparent, semi-transparent or opaque. Due to the single- or multilayered system on the support, however, they are additionally capable of generating more or less intense and lustrous interference colours.

Polymer or metal flakes, also known as holographic pigments, can likewise also be employed as flake-form effect pigments. In addition, it is also possible to employ flake-form effect pigments whose choice of material in the support or coating additionally results in magnetic, electrically conductive, fluorescent or other functional properties of the corresponding effect pigments.

The effect pigments described above may be present individually or as a mixture of two or more in the pigmented thermoplastic film employed in accordance with the invention.

Effect pigments which can be employed are, for example, the commercially available functional pigments, interference pigments or pearlescent pigments offered by Merck KGaA under the names Iriodin®, Colorstream®, Xirallic®, Miraval®, Ronastar®, Biflair®, Minatec®, Lustrepak®, Colorcrypt®, Colorcode® and Securalic®, Mearlin® from Mearl, metal-effect pigments from Eckart and optically variable effect pigments, such as, for example, Variochrom® from BASF, Chromafflair® from Flex Products Inc., Helicone® from Wacker, holographic pigments from Spectratec and other commercially available effect pigments.

The geometrical thickness of the pigmented thermoplastic film employed in accordance with the invention can vary in a broad range and is preferably in the range from 20 to 2000 μm, in particular from 50 to 500 μm.

Suitable materials for the thermoplastic melt in the first process step of the process according to the invention are the thermoplastic materials already mentioned above, i.e., in particular, polystyrene (PS), polystyrene blends, styrene-acrylonitrile (SAN), acrylate-styrene-acrylonitrile (ASA), polycarbonate (PC), polymethyl methacrylate (PMMA), acrylonitrile-butadiene-styrene (ABS) and ABS/PC blends, polyamide (PA) or polyester (PE).

Further ingredients are optionally additives and assistants which are able to influence the mechanical strength, the functional properties or the optical properties of the body or base moulding, for example reinforcing glass or carbon fibres, carbon blacks, conductive additives, particulate fillers and/or inorganic or organic colourants, as well as further assistants and additives.

When selecting the materials for the thermoplastic film and the thermoplastic melt, it is particularly important to match the melting behaviour and the melting temperatures of the two materials as far as possible in order that both constituents of the polymeric base moulding are able to bond well to one another without an adhesion-promoting layer being necessary between the two. It is therefore particularly preferred to use identical or at least partly identical materials for the thermoplastic melt and the plastic component of the thermoplastic film. If this is not possible, it is advantageous to use plastic materials whose melting behaviour and melting temperature are compatible with one another and have great similarity. The temperature of the thermoplastic melt here should have at least the value of the glass transition temperature T_{G} of the plastic component of the pigmented thermoplastic film. In addition, the molecular and morphological structure of the plastic materials involved and their surface energy and polarity play an important role for the adhesion of the two plastic materials to one another. The starting materials for the thermoplastic film and the transparent thermoplastic melt can be selected in accordance with these prerequisites, which the person skilled in the art is able to do on the basis of his expert knowledge.

In the case where it is necessary to employ plastic materials which do not satisfy the above conditions for the thermoplastic film pigmented with flake-form effect pigments and the thermoplastic melt, an adhesion-promoting layer applied to the thermoplastic film surface projecting into the injection mould cavity may be helpful in the thermal bonding of film and melt. The adhesion-promoting layer ensures an unbreakable bond of film and plastic melt and can likewise be selected by the person skilled in the art on the basis of his expert knowledge. However, an adhesion-promoting layer of this type should only be employed in exceptional cases. It is therefore preferred to carry out the process according to the invention without an adhesion-promoting layer, in both the first and second process steps.

In addition, the choice of material for the thermoplastic film must also be carried out with a view to good adhesion to the transparent plastic produced in the second process step. However, after polymerisation, the starting materials available for this plastic generally do not readily bond strongly to the above-mentioned materials for the thermoplastic film.

In the first process step of the process according to the invention, the thermoplastic film, which is fixed to surface A′, warms during introduction of the thermoplastic melt into the injection mould until it becomes mechanically deformable and is able to come into close form-fitting contact with inside surface A′. The three-dimensional pattern present in A′ is thereby replicated on the film surface facing surface A′ (front-side film surface) in the form of the negative of the three-dimensional pattern present on surface A′. At the same time, the hot plastic melt flows into the cavity between the thermoplastic film and inside surface B′ and “floods” the back-side film surface. On subsequent curing of the resultant base moulding, a strong, positive bond forms between the thermoplastic film pigmented with flake-form effect pigments and the plastic formed from the transparent thermoplastic melt and forms the body of the base moulding. On its front-side outside surface (A″) formed by the thermoplastic film, the base moulding has a three-dimensional pattern which corresponds to the negative image of the three-dimensional pattern which is present on surface A′ in the interior of the injection mould. Depending on the outer shape of inside surface B′ and its surface nature, the back-side surface B″ of the polymeric base moulding can be smooth and flat or coarsely and/or finely structured.

The colouring, functionality and gloss behaviour of surface A″ of the base moulding are crucially impacted by the flake-form effect pigments present in the pigmented thermoplastic film, optionally supplemented by additional colourants and/or fillers which are also located in or on the thermoplastic film.

In addition, it is advantageous for the later visibility of the three-dimensional pattern seen from the surface of the finished polymeric moulding if the thermoplastic melt comprises a soluble colourant or a particulate colourant. In particular, a dark colouring of the body of the base moulding or its opacity increases the later visibility of the three-dimensional pattern in an advantageous manner. Soluble colourants lead to the thermoplastic melt and thus the body of the polymeric base moulding having an inherent colour, but have no or virtually no adverse effect on the transparency of this part of the polymeric moulding. By contrast, conventional particulate colourants, i.e. conventional organic or inorganic coloured pigments, in sufficient amount can give rise to an opaque body of the base moulding.

After solidification of the thermoplastic composition in the injection mould, the body formed therefrom can adopt any desired two- or three-dimensional shape and size and is, in particular, not limited with respect to its colouring and transparency. The body is preferably coloured while at the same time being transparent or translucent, but can also, in particular, be made opaque, which is particularly preferred.

In accordance with the invention, a plastic and a polymeric moulding or, here, body made therefrom is regarded as transparent if it transmits wavelengths of visible light in such a way that it is see-through, i.e. a corresponding substrate or background is visible through the body. A plastic and a moulding or body made therefrom is regarded as translucent if it transmits wavelengths of visible light to such an extent that it allows light to pass through, but is not transparent, i.e. a corresponding substrate or background is not visible through the body. A plastic or a moulding or body made therefrom is to be regarded as opaque if it absorbs and/or reflects and/or scatters wavelengths of visible light virtually completely and accordingly is neither translucent nor transparent.

The softening of the polymeric film material during introduction of the polymeric plastic melt in the first process step at the same time facilitates renewed mobility of the flake-form effect pigments present in the thermoplastic film. These are usually present in predominantly directed form in the thermoplastic, but still thermally untreated film, more precisely with their principal axis aligned substantially parallel to the film surface, as described above. Correspondingly pigmented films therefore have no weld lines. Due to the deformation of the pigmented thermoplastic film at inside surface A′, a spatial reorientation of the flake-form effect pigments present in the film arises. The form-fitting adaptation of the plastic component of the film to inside surface A′ of the injection mould at the same time as warming of the film leads to the flake-form effect pigments in the part of surface A′ that carries the three-dimensional pattern aligning in such a way that, in addition to the local deformation of the film body, the flake-form effect pigments also reorient themselves parallel to the bumps and/or pits of the three-dimensional pattern and thus likewise replicate and, due to their modified reflection behaviour, virtually enhance the three-dimensional pattern of surface A′. The flake-form effect pigments are shifted out of their parallel orientation at the edges of these bumps and/or pits and remain at an acute or steep angle in the thermoplastic polymeric composition of the film in an alignment which is inclined in relation to the film surface. This causes the reflection behaviour of the flake-form effect pigments at these points of the film to change, which leads to generally reduced reflection compared with the flat areas at a steep viewing angle. This reorientation of the effect pigments is fixed during the solidification process of the thermoplastic composition.

In accordance with the invention, the three-dimensional pattern on the front-side outside surface of the base moulding, which is formed by the thermoplastic film, has bumps and/or pits, which can have a height/depth from about 2 μm to a few centimetres and line widths from 50 μm to 2000 μm. The height/depth of the bumps/pits is preferably 10 μm to 50 mm, in particular from 10 μm to 500 μm, and the line widths are preferably in the range from 100 μm to 1000 μm. The area extent of the three-dimensional pattern can range from a few square millimetres to a several hundred square centimetres. These dimensions are essentially determined by the size and thickness of the base moulding and the target line sharpness of the virtual three-dimensional pattern which is visible in the resultant polymeric moulding and can be adjusted correspondingly.

The bumps and/or pits on the front-side outside surface of the base moulding, which together form a three-dimensional pattern, are formed at least on one part-area of the front-side outside surface, optionally also on the entire front-side outside surface, of the base moulding. This pattern is preferably macroscopically visible and is, for example, in the form of a pictorial object, an alphanumeric motif, a line and/or dot pattern, a logo, a code or an abstract pattern.

For the purposes of the present invention, it is important that the three-dimensional pattern on the front-side outside surface of the base moulding does not correspond to the outer shape of the base moulding, i.e. the bumps and/or pits forming the pattern on the surface of the base moulding do not form its outer shape, but instead are present in addition to possible bumps and/or pits on the outside surface of the base moulding which determine the outer shape and are clearly evident as texture of the outside surface formed by the pigmented film. Thus, for example, in the case of a base moulding which has the outer shape of a hemisphere located on a flat plate, the three-dimensional pattern in accordance with the present invention is not represented by the hemispherical bump on the plate base body, although this is likewise a bump on the outside surface, but instead, for example, by a three-dimensionally embossed logo on the hemisphere or plate base body.

In accordance with the present invention, the three-dimensional pattern is intended to be a preferably haptically perceptible pattern comprising bumps and/or pits on the surface of the base moulding, which do not determine the outer shape of the base moulding and are clearly evident as texture on its front-side outside surface.

If only a part-area of this outside surface of the base moulding is arranged facing the cavity of the second injection mould, it goes without saying in accordance with the present invention that the three-dimensional pattern comprising bumps and/or pits is located on precisely this part-area of the outside surface of the base moulding.

The second process step of the injection-moulding process according to the invention corresponds in its essential working steps to a reactive injection-moulding process (RIM technology), which has been known for years, in which a partable injection mould is employed whose interior cavity corresponds to the final shape of the plastic moulding to be produced. A prefabricated base plastic moulding is introduced into this cavity, where the base plastic moulding is subsequently flooded on at least one of its outside surfaces with a mixture of reactive, flowable starting materials which are capable of polymerisation with one another, and the resultant surface coating of the base plastic moulding is allowed to solidify in the injection mould. The solid surface coating formed on the plastic moulding corresponds in principle to direct coating inside the injection mould. The plastic moulding produced is subsequently demoulded or removed from the opened injection mould.

Such processes and the special injection moulds and reactive materials developed for this purpose are known per se and are offered by various manufacturers under the names ColorForm, SkinForm, Clearmelt, etc. They represent an adaptation of a conventional injection-moulding process to PUR technology, since most of the reactive starting materials employed for the final surface coating are polyol/isocyanate mixtures.

The two-step injection-moulding process according to the invention can be carried out using either one injection mould for one-step RIM technology (one-shot process) or two separate injection moulds for multistep RIM technology.

In the so-called one-shot process, the production of the polymeric base moulding and its surface coating take place inside a single injection mould having two interior cavities which are different from one another. Firstly, the polymeric base moulding is produced in accordance with the invention, as described above, in a first process step from a thermoplastic melt and a thermoplastic film pigmented with effect pigments in a first cavity of the injection mould, which is provided on one of its inside surfaces (A′) with a three-dimensional structure comprising bumps and/or pits. In this first process step, the polymeric base moulding is provided on at least that part of its outside surface that is formed by the thermoplastic film, with bumps and/or pits, which together form a three-dimensional pattern.

After curing of the base moulding, the injection mould is opened and the base moulding is transferred via suitable turning, rotating or pushing devices into a second cavity of the injection mould, which likewise has two inside part-surfaces, where one of the inside part-surfaces of the cavity already carries the base moulding and already represented surface B′ of the first cavity of the injection mould. The three-dimensional pattern consisting of the bumps and/or pits on the film surface of the base moulding faces the cavity, which is located between this outside film surface of the base moulding and the second inside surface of the second cavity.

The injection mould is subsequently closed and a mixture of at least two flowable components which react with one another with polymerisation is introduced into the remaining second cavity of the injection mould between the structured surface of the thermoplastic film and the second inside surface of the injection mould. It goes without saying that the nozzles of the injection mould must have a corresponding technical design that ensures rapid introduction of the reactive starting components into the second cavity and prevents premature polymerisation of the reactive starting mixture. The temperature and pressure programme and the technical design of the injection mould must also be adjusted correspondingly. However, these design prerequisites exist in the equipment present in the prior art.

Due to the generally very low viscosity of the mixture of the reactive starting components, the remaining cavity is very rapidly completely filled with this mixture. The introduction of the mixture of the reactive starting components into the second interior cavity of the injection mould is preferably carried out at only moderately increased pressure (0.5 to about 15 MPa) and at elevated temperature, in each case depending on the materials used. Due to the effect of the heated reactive starting compounds and the pressure and temperature that the liquid reactive starting compounds exert on the pigmented thermoplastic film during the introduction into the cavity of the injection mould and during the polymerisation reaction, the thermoplastic film reaches a surface temperature which allows a strong bond of the film to the plastic formed from the components that have been introduced. The specific temperature of the starting components in each case depends on the type of starting components processed and their reactivity and is usually in the range from 20° C. to 150° C., preferably from 40° C. to 70° C., with a usual mould temperature in the range from 40 to 180° C. If necessary, the reaction can also take place under inert gas, for example in a nitrogen atmosphere.

Since the thermoplastic film in the upstream first process step is already strongly bonded to the body to form a polymeric base moulding, the three-dimensional pattern comprising bumps and/or pits on the surface of the pigmented film is mechanically supported by the body of the base moulding and is therefore dimensionally stable, so that it withstands the introduction of the reactive plastic components in the second process step without damage, although this takes place at elevated temperature.

The polymerisation reaction and solidification (crosslinking) of the at least two reactive starting components with formation of a transparent plastic in the second process step takes place inside the injection mould within a short period (cycle time about 0.5 to 5 min).

During the introduction and solidification of the mixture of at least two flowable components which react with one another with polymerisation into the injection mould, the thermoplastic film located on the front-side surface of the base moulding warms, in spite of the comparatively low working temperatures, to such an extent that it bonds to the transparent plastic formed in the polymerisation reaction of the reactive starting components that have been introduced. As in the first process step, this is a strong and positive bond of the thermoplastic film to the transparent plastic formed in situ, meaning that the film is permanently enclosed in the interior of the resultant polymeric moulding.

At the same time, the heated mixture of at least two flowable components which react with one another with polymerisation flows into the cavity between the thermoplastic film and inside surface a and floods over the three-dimensional pattern on the front-side surface of the thermoplastic film. This pattern corresponds to the mirror image of the three-dimensional pattern applied to inside surface A′ of the first injection mould and is, viewed from the surface of the polymeric moulding formed from the transparent plastic formed, identical in appearance to the actual three-dimensional pattern on the outside surface of the base moulding, but, due to the light reflections emanating from the pigments, is perceived more clearly and optically more attractively. During subsequent solidification and curing of the polymeric moulding thus formed, a strong, positive bond forms between the thermoplastic film pigmented with flake-form effect pigments and the transparent plastic formed from the mixture of the reactive, flowable components which are capable of polymerisation, which is manifested in the subsequent cooling or heating operation.

The outer layer of transparent plastic which forms the outside visible surface of the resultant moulding adds an additional depth effect to the virtual three-dimensional pattern comprising flake-form effect pigments with various orientations which is obtained in the interior of the moulding through an additional optical depth effect.

When the moulding has solidified sufficiently, it can be demoulded or removed from the injection mould. Post-curing, which is necessary in most cases, then takes place outside the injection mould.

The resultant moulding has an outer shape which is determined by the shape of the base moulding the one hand and by the shape of the second inside surface of the second injection mould on the other hand. Viewed from the side of the transparent plastic (i.e. the front-side outside surface of the polymeric moulding), which is the “visible side” of the moulding obtained, the moulding in accordance with the present invention exhibits in its interior a virtual, deep-lying, glossy, three-dimensional pattern which is formed from flake-form effect pigments. If the second surface of the second injection mould is the polished surface that is usually employed, the resultant polymeric moulding does not have on its outside surface (visible side) a three-dimensional shape which corresponds to the three-dimensional effect pigment pattern visible in the interior of the moulding. Nevertheless, however, the said second surface of the injection mould may likewise have a coarse or fine texture which leads, in the resultant moulding, to a coarse or fine structure on its outside surface, which additionally three-dimensionally enhances or supplements the three-dimensional pattern visible in the interior of the moulding.

Gloss and colouring of the flake-form effect pigments in the thermoplastic film lead to a particularly strong perception of the virtual three-dimensional pattern on the surface of the moulding produced. The visible three-dimensional pattern here is significantly more pronounced than would be expected from the actual deformation of the thermoplastic film, since displacement of the flake-form effect pigments out of the parallel position, even by only a few angle degrees, results in a significant change in their reflection properties.

Particularly good visibility of the three-dimensional pattern on the outside surface of the resultant moulding arises if the body of the base moulding is opaque and/or is preferably grey or black coloured, in particular if the thermoplastic film is pigmented with flake-form effect pigments which consist entirely of transparent materials and only have interference colours, but no absorption colour.

If the transparent plastic produced in situ comprises a soluble colourant or small amounts of a particulate colourant, the colouristic impression, perceptible from the side of the front outside surface of the resultant moulding, of the virtual three-dimensional pattern can also be modified as desired. Although soluble colourants in suitable amount lead to an inherent colour of the plastic produced in situ and of the polymeric moulding part produced therewith, they have, however, virtually no or absolutely no adverse effect on the transparency of this part of the moulding.

Besides the one-step RIM process, the use of a multistep RIM process is also particularly suitable for the reactive injection-moulding process according to the invention.

On use of a multistep RIM process, the base moulding is produced separately in advance in an injection-moulding process in accordance with the first process step of the process according to the invention. If a multistep RIM process of this type is used in the process according to the invention, the injection mould employed for the second process step has only a single interior cavity.

For this purpose, an injection mould suitable for an RIM process is provided which has, in one of the injection mould parts, an insert or another device which is able to accommodate the prefabricated base moulding from the first process step. This base moulding can have a two- or three-dimensional shape, where, for the purposes of the present invention, flat structures, such as, for example, films or plates, are to be regarded as two-dimensional, whereas other spatial structures which do not have a flat shape are to be regarded as three-dimensional. Three-dimensional base mouldings are not restricted in shape so long as the injection mould is able to accommodate the corresponding base mouldings and the latter can be fixed to, in or on the inside surface of the corresponding injection mould part.

The base moulding here is fixed to the inside surface of the injection mould part in such a way that its front outside surface formed by the thermoplastic film faces the cavity of the injection mould (in accordance with the invention, front outside surface of the base moulding is taken to mean: one of the two principal surfaces of a film or plate; the convex surface or part-areas thereof in the case of three-dimensional hollow bodies; at least part of the entire outside surface in the case of three-dimensionally shaped bodies having a closed surface).

All further process steps here correspond to the process steps described above using a one-step process, namely:

After the base moulding, which has a two- or three-dimensional shape and a front-side outside surface comprising a film pigmented with effect pigments, has been fixed to one of the inside surfaces of the injection mould in such a way that the front-side outside surface of the base moulding faces the cavity, where this outside surface has, at least on a part-area thereof, bumps and/or pits which together form a three-dimensional pattern, the injection mould is closed and a mixture of at least two flowable components which react with one another with polymerisation is subsequently introduced into the interior cavity between the thermoplastic film and the second inside surface of the injection mould, at least partly flooding the thermoplastic film, where the flowable components solidify with one another by polymerisation to give a transparent plastic and the thermoplastic film forms a strong and positive bond to the transparent plastic formed during the polymerisation. The injection mould is subsequently heated or cooled, depending on the type of components employed, and the resultant polymeric moulding is demoulded or removed. The resultant moulding has an outside surface comprising a transparent plastic, where a virtual three-dimensional pattern formed by the flake-form effect pigments, which is not present on the surface itself, is visible at least on part of this outside surface. The outside surface serves merely as optical enhancement medium for the three-dimensional pattern formed inside the moulding by the flake-form effect pigments and can be glossy or matt, smooth or structured, hard or with a soft-touch effect, depending on the thickness and material nature. In each case, the outside surface provides the resultant moulding with the desired resistance to external influences, such as, for example, ageing, weathering, mechanical impairments, and/or the requisite scratch resistance.

Suitable as material for the mixture of at least two flowable components which are capable of polymerisation with one another are all substance mixtures which can be processed in the known RIM moulds and give rise to transparent plastics in situ by polymerisation of the at least two components with another.

Known suitable mixtures are two-component mixtures that give rise to polyurethane or polyurea plastics by polymerisation. Mixtures of this type generally comprise a liquid binder component and a liquid hardener or crosslinker component. The known systems often comprise, as liquid binder component, an isocyanate-reactive component, such as polyamines or polyols, whereas the liquid crosslinking component comprises an isocyanate. The two components react by polyaddition on mixing to give crosslinked polyurea or polyurethane plastics. The crosslinking reaction here proceeds even under moderate temperature and pressure conditions.

The liquid reactive mixtures which can be employed in the process according to the invention therefore preferably comprise at least one isocyanate component and at least one isocyanate-reactive component, for example a polyol or a polyamine.

In addition, catalysts, assistants and additives, particulate fillers, release agents or also polymerisation retardants can additionally be added if necessary.

Isocyanate-reactive polyols which have proven particularly suitable for the polyurethane preparation are, inter alia, polymeric or oligomeric polyols, such as, for example, polyether-polyols, polyester-polyols and/or polycarbonate-polyols.

The isocyanate-reactive polyamines employed are preferably polymeric or oligomeric polyamines, such as, for example, polyether-polyamines and/or polyester polyamines.

Suitable isocyanate compounds are, in particular, aromatic, araliphatic, aliphatic or cycloaliphatic di- and/or polyisocyanates or mixtures thereof.

In certain embodiments, the isocyanate component comprises a diisocyanate of the formula R(NCO)₂, where R represents an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms. Specific examples of suitable isocyanate compounds are xylylene diisocyanate, tetramethylene diisocyanate, 1,4-diisocyanatobutane, 1,12-diisocyanatododecane, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1,4-phenylene diisocyanate, 2,6-toluylene diisocyanate, 2,4-toluylene diisocyanate, 1,5-naphthylene diisocyanate, 2,4′- or 4,4′-diphenylmethane diisocyanate, 4,4′-diphenyldimethylmethane diisocyanate, a,a,a′,a′-tetramethyl-m-xylylene diisocyanate, a,a,a′,a′-tetramethyl -p-xylylene diisocyanate, triphenylmethane 4,4′,4″-triisocyanate or mixtures thereof. Also suitable are monomeric triisocyanates or polyisocyanate adducts which contain isocyanurate, iminooxadiazinedione, urethane, biuret, allophenate, uretdione, and/or carbodiimide groups. The isocyanates can contain 3 or more isocyanate functionalities and can be prepared, for example, by trimerisation or oligomerisation of diisocyanates or by reaction of diisocyanates with polyfunctional compounds containing hydroxyl or amine groups.

In addition, the coating compositions may additionally comprise silicone compounds.

Other thermocuring resins can also be prepared in this process step if their preparation in the injection mould does not lead to undesired by-products. For example, anionic polymerisation of ε-caprolactam to PA6 by means of suitable catalysts is just as possible as the preparation of thermocuring polydicyclopentadiene resins or thermocuring polyester resins. However, preference is given to the use of reactive components which lead to polyurethanes or polyureas as surface coating on the thermoplastic film.

Isocyanate-reactive components, such as polyamines or polyols, and crosslinking components, such as aromatic, araliphatic, aliphatic or cycloaliphatic di- and/or polyisocyanates (as described above) are particularly preferably employed for the preparation of polyurethanes.

The liquid, reactive starting materials for the in situ preparation of the transparent plastic can be employed in colourless or coloured form and give rise to transparent plastic layers after solidification.

The outer layer of transparent plastic which forms the outside surface of the resultant moulding enhances the virtual three-dimensional pattern of flake-form effect pigments which is obtained in the interior of the moulding through an additional optical depth effect.

The present invention also relates to a polymeric moulding which has a thermoplastic base moulding and a transparent surface layer located thereon which comprises a transparent plastic formed by reactive polymerisation of at least two flowable components, where the thermoplastic base moulding and the transparent surface layer have an interface with one another which is formed by a thermoplastic film pigmented with flake-form effect pigments which has a film surface which faces the transparent surface of the polymeric moulding and has a three-dimensional pattern comprising bumps and/or pits which is virtually enhanced by alignment of the flake-form effect pigments parallel to the bumps and/or pits in the thermoplastic film and is visible through the transparent surface layer. The outside surface layer of the polymeric moulding itself does not have a corresponding spatial three-dimensional pattern. Such mouldings are produced by the injection-moulding process according to the invention described above.

The moulding in accordance with the present invention is a polymeric moulding which consists of at least two plastic materials which are different from one another, at least one of which forms the body of the base moulding and the other forms a transparent surface layer on the front outside surface of the base moulding which is formed by the thermoplastic film. The plastic material of the thermoplastic film is particularly preferably identical to the material of the body of the base moulding.

The visibility of the virtual three-dimensional pattern generated by the spatial alignment of the flake-form effect pigments in the thermoplastic film can be enhanced in an advantageous manner by the body of the base moulding containing soluble and/or particulate colourants. This gives a body which is coloured and at the same time appears optically transparent, translucent or opaque. The use of particulate colourants (coloured pigments), which lead to an opaque appearance of the body, is particularly advantageous. Such opacity of the body of the base moulding enhances the optical contrast between the body and the flake-form effect pigments present in the surface layer of the base moulding formed by the thermoplastic film and leads to particularly good visibility of the virtual three-dimensional pattern on the surface of the resultant polymeric moulding.

The material compositions of body, thermoplastic film, flake-form effect pigments and transparent plastic have already been described in detail above. Reference is expressly made here to this description with respect to the moulding according to the invention.

The moulding according to the invention can optionally also have an adhesion-promoting layer between the pigmented thermoplastic film and the cured, transparent plastic produced in situ. However, this is not preferred and, in the case of a specific choice of material of the plastic component of the thermoplastic film and starting materials for the transparent plastic, as described above, is neither necessary nor advantageous. On the contrary, it is a particular advantage of the process according to the invention that good adhesion between all polymeric constituents of the polymeric plastic body can be ensured without the need to employ adhesion -promoting layers or additional layers which would have to protect the three-dimensional pattern located on the front surface of the base moulding against mechanical and thermal impairment during the process.

The virtual three-dimensional pattern visible on the outside surface (visible side) of the moulding according to the invention is the positive image of the bumps and/or pits located on the front-side surface of the base moulding. However, this image is generated principally by the different orientation of flake-form effect pigments in the thermoplastic interlayer (film) located in the interior of the moulding according to the invention, whereas the three-dimensional pattern actually located on the surface of the base moulding in the resultant moulding is only weakly visible or is invisible.

As already described above, the size of the vertical and horizontal extent of the visible three-dimensional pattern on the outside surface of the moulding according to the invention can vary in broad ranges, which is selected depending on the size of the base moulding and the thickness of the thermoplastic film and the intended purpose of the three-dimensional pattern on the polymeric moulding (example: code versus decorative effect). The thickness of the thermoplastic film generally represents the upper limit for the height or depth of the bumps and/or pits on the surface of the base moulding, but in individual cases these may also exceed the thickness of the thermoplastic film.

The three-dimensional pattern on the front-side outside surface of the base moulding has bumps and/or pits from a height/depth of about 2 μm to several centimetres and line widths from 50 μm to 2000 μm. The area extent of the three-dimensional pattern can range from a few square millimetres to several hundred square centimetres and is, like the height/depth and width of the pits or bumps, dimensioned in accordance with the above-mentioned criteria.

The base moulding's front-side surface, which is formed by the thermoplastic film and contains the three-dimensional pattern, is located in the interior of the resultant polymeric moulding and cannot be separated from it.

The flake-form effect pigments arranged in the film interlayer each have a longitudinal axis, which corresponds to the longest dimension of the pigments, and have different orientations of these longitudinal axes in the film interlayer, relative to a base area of the interlayer, as has already been described above. This different orientation of the flake-form effect pigments leads to different light reflection of the effect pigments in the case of incident light and leads to a virtual, glossy pattern with a three-dimensional appearance in the interior of the polymeric moulding according to the invention which is visible on its outside surface, but is not haptically perceptible.

Instead, the outer surface layer of the moulding consists of a transparent plastic and preferably has, apart from the outer shape, no additional surface structure. In individual cases, however, such an additional texture/structure of the outside surface may be appropriate or useful. The thickness of the outer surface layer comprising a transparent plastic prepared in situ can, in accordance with the invention, be matched variably to the respective requirements for use of the final moulding. It can be in the range from 0.1 to 30 mm, preferably in the range from 0.1 to 20 mm and particularly preferably in the range from 0.1 to 5 mm.

The virtual three-dimensional pattern visible on the outside surface of the polymeric moulding is as such not haptically perceptible on this surface and is therefore protected against mechanical influences. At the same time, it is readily perceptible and optically attractive due to the different light reflection of the flake-form effect pigments. The transparent plastic layer forming the outside surface of the polymeric moulding increases the impression of depth and thus the visually perceptible three-dimensionality of the pattern. In addition, this surface of the moulding has, due to the materials used, high resistance to negative external influences and/or high scratch resistance and can be provided in its feel and optics from hard and high-gloss to matt and with a soft-touch feel. Variable textures on the outside surface, which can advantageously supplement the three-dimensional virtual pattern formed by the effect pigments, are likewise possible

The present invention also relates to the use of the polymeric moulding described above as decorative and/or labelling element or part of durable consumer goods.

Durable consumer goods here are essentially and preferably packaging, products in the electrical and electronics industry, domestic appliances, furniture, clothing, bags, shoes, sports articles or in particular vehicles and vehicle parts. In principle, however, the polymeric mouldings according to the invention can be employed in all areas in which polymeric mouldings which have a readily visible, attractive three-dimensional pattern which at the same time cannot be felt on the surface can advantageously be employed. In articles of this type, the virtual three-dimensional pattern can be employed for purely artistic, decorative reasons, but also for the purpose of product labelling with batch numbers, manufacturer's data and the like.

The present invention provides an injection-moulding process with the aid of which it is possible to produce polymeric mouldings which exhibit on at least one of their surfaces a glossy, optically attractive, virtual three-dimensional pattern which exhibits an appearance which can be varied in colour, gloss and functionality and may contain fine lines with high precision. For many areas of application of injection mouldings which require special combinations of polymeric materials, a process is thus created for improving their optical appearance without adhesion problems arising between the various plastics. Furthermore, the process according to the invention has the advantage that, even in the case of polymeric mouldings, achievement of impressive three-dimensional patterns which are based on the spatial alignment of flake-form effect pigments does not require pigmentation of the entire polymeric moulding with these flake-form effect pigments, but instead only part of the moulding, which may, as required, also be relatively small (for example only 10% by weight), based on the total weight of the polymeric moulding. In addition, the polymeric mouldings according to the invention have no weld lines. The process according to the invention can be carried out using conventional one- and multistep RIM injection-moulding equipment and is therefore comparatively inexpensive and can be adapted in line with needs. With the aid of the process according to the invention, complex polymeric mouldings having a mechanically stable surface which are free from weld lines and are impressively coloured and patterned with effect pigments can be produced in a simple, variable manner. The resultant polymeric mouldings according to the invention are durable and have a generally unembossed surface of high optical and mechanical attractiveness and a virtually indestructible three-dimensional virtual pattern having high line sharpness. They have a uniform colour and if desired, high gloss and can be employed in a variable manner in many industrial and decorative areas of application.

The invention is intended to be explained in greater detail below with reference to examples, but is not intended to be restricted thereto.

### EXAMPLE 1

A film (PC/ABS, Bayblend® T 65 HI, product from Covestro) having a content of 2.0% by weight of Colorstream® F 10-51 Lava Red (flake-form effect pigment based on SiO₂ substrates, particle size 5-50 μm, product from Merck KGaA) having a thickness of approx. 300 μm is produced in a size of 100×150 mm by means of an injection-moulding process.

The film mass-coloured with the effect pigment is laid in the injection mould of an Arburg Allrounder 320 M injection-moulding machine, whose first inside surface, which faces the cavity of the injection mould, has been provided with a three-dimensional structure in the form of the mirror image of a logo. The film is electrostatically fixed to this inside surface.

After the mould has been closed, a plastic melt (PC/ABS, Bayblend® T 65 HI, product from Covestro AG) is injected into the remaining cavity between the pigmented thermoplastic film and the other inside surface of the injection mould which has not been provided with the three-dimensional structure (nozzle side). The injection operation is carried out at a temperature in the range from 180 to 260° C. and a pressure in the range from 300 to 900 bar. The film positively bonds to the body formed to give a polymeric base moulding which has on one of its surfaces a three-dimensional pattern in the form of a logo in a glossy surface pigmented with effect pigments. Since the logo has various pits of only about 100-600 μm each, its actual three-dimensional structure is only weakly perceptible optically, but can be felt haptically.

The base moulding produced beforehand is applied to an inside surface of the injection mould in a suitable RIM injection moulding tool in such a way that the logo on the film surface of the base moulding faces the interior cavity of the injection mould. The mould is then closed. A reactive mixture (2-component PUR system) is introduced into the cavity still remaining between the pigmented film surface and the free inside surface of the injection mould and allowed to cure. The reactive mixture used is a mixture of 49% by weight of component 1, consisting of Desmophen® XP2488 (24.15% by weight), Desmophen® C1100 (24.15% by weight), Dabco® T-12 (0.5% by weight) and FC 983 (0.2% by weight), and 51% by weight of component 2, consisting of Desmodur® N-3600, all products from Bayer MaterialScience.

After the cooling operation and opening of the mould, a moulding is obtained whose first outside surface exhibits an area, giving the impression of lying behind glass, having a uniformly strong red gloss with a finely structured virtual three-dimensional pattern located therein in the form of a logo which is formed by the flake-form effect pigments in the film and which corresponds to the motif of the logo on the surface of the base moulding. The other principal surface of the moulding is flat, translucent and has a pale colour.

### EXAMPLE 2

A film (PC/ABS, Novodur Ultra 4105, product from Ineos Styrolution Group GmbH) having a content of 2.0% by weight of Miraval® 5411 (flake-form effect pigment based on borosilicate substrates, particle size 20-200 μm, product from Merck KGaA) and 0.2% by weight of PV Fast Blue B2G01 (product from Clariant International Ltd.) having a thickness of approx. 300 μm is produced in a size of 100×150 mm by means of an injection-moulding process.

The film mass-coloured with the effect pigment is laid in the injection mould of an Arburg Allrounder 320 M injection-moulding machine, whose first inside surface, which faces the cavity of the injection mould, has been provided with a three-dimensional structure in the form of the mirror image of a logo. The film is electrostatically fixed to this inside surface.

After the mould has been closed, a plastic melt (ABS, Terluran® GP22, product from BASF, having a carbon black content of 0.5% by weight) is injected into the cavity remaining between the pigmented thermoplastic film and the other inside surface of the injection mould which has not been provided with the three-dimensional structure (nozzle side). The injection operation is carried out at a temperature in the range from 180 to 260° C. and a pressure in the range from 300 to 900 bar. The film positively bonds to the body formed to give a polymeric base moulding which has on one of its surfaces a three-dimensional pattern in the form of a logo in a glossy-blue surface pigmented with effect pigments. Since the logo has various pits of only about 100-600 μm each, its actual three-dimensional structure is only weakly perceptible optically, but can be felt haptically.

The base moulding produced beforehand is applied to an inside surface of the injection mould in a suitable RIM injection mould tool in such a way that the logo on the film surface of the base moulding faces the interior cavity of the injection mould. The mould is then closed. A reactive mixture (2-component PUR system) is introduced into the cavity still remaining between the pigmented film surface and the free inside surface of the injection mould and allowed to cure. The reactive mixture used is the mixture according to Example 1.

After the cooling operation and opening of the mould, a moulding is obtained whose first outside surface exhibits an area, giving the impression of lying behind glass, having a uniformly blue gloss with a partly glittery, finely structured virtual three-dimensional pattern with bright gloss located therein in the form of a logo which is formed by the flake-form effect pigments in the film and which corresponds to the motif of the logo on the surface of the base moulding. The other principal surface of the moulding is flat, opaque and has a dark-grey colour

1. Injection-moulding process for the generation of virtual three-dimensional patterns in polymeric mouldings, where
in a first process step
in an injection mould which has injection-mould parts A and B which can be separated from one another and which have an inside surface A′ and B′ respectively and together form an interior cavity, where inside surface A′ has bumps and/or pits on a base area which form a three-dimensional pattern, with the injection mould opened
a thermoplastic film pigmented with flake-form effect pigments is fixed to surface A′,
the injection mould is closed,
a thermoplastic melt is introduced into the interior cavity between the thermoplastic film and surface B′ of injection mould part B,
and the injection mould is heated or cooled with formation of a polymeric base moulding, where the base moulding has a body comprising a thermoplastic and a surface comprising the thermoplastic film which has a three-dimensional pattern comprising bumps and/or pits which is virtually enhanced by alignment of the flake-form effect pigments parallel to the bumps and/or pits in the thermoplastic film, and where
in a second process step
the polymeric base moulding is introduced into an injection mould having an interior cavity in such a way that the base moulding's outside surface, which has the thermoplastic film with bumps and/or pits, faces the interior cavity,
the injection mould is closed, and
a mixture of at least two flowable components which react with one another with polymerisation is introduced into the interior cavity remaining, at least partly flooding the thermoplastic film, where the flowable components solidify with one another by polymerisation to form a transparent plastic and the thermoplastic film forms a strong and positive bond to this plastic, and
the injection mould is heated or cooled and subsequently
the resultant moulding, which has an outside surface comprising the transparent plastic and a virtual three-dimensional pattern formed by the flake-form effect pigments on at least part of this outside surface, is demoulded or removed.

2. Process according to claim 1, characterised in that the thermoplastic film has been mass-coloured with flake-form effect pigments.

3. Process according to claim 1, characterised in that the three-dimensional pattern is a macroscopic pattern in the form of a pictorial object, an alphanumeric motif, a line and/or dot pattern, a logo, a code or an abstract pattern.

4. Process according to claim 1, characterised in that the flake-form effect pigments are selected from the group pearlescent pigments, interference pigments, metal-effect pigments, flake-form functional pigments, flake-form structured pigments, or a mixture thereof.

5. Process according to claim 1, characterised in that the flake-form effect pigments have a particle size in the range from 5 to 250 μm and an aspect ratio of at least 2.

6. Process according to claim 1, characterised in that the flake-form effect pigments are present in the pigmented thermoplastic film in an amount of 0.1 to 20% by weight, based on the total weight of the pigmented film.

7. Process according to claim 1, characterised in that, in addition to the flake-form effect pigments, the pigmented thermoplastic film also comprises further organic or inorganic coloured pigments, dyes and/or fillers.

8. Process according to claim 1, characterised in that the thermoplastic melt comprises particulate or soluble colourants.

9. Process according to claim 1, characterised in that the body of the base moulding is transparent, translucent or opaque.

10. Polymeric moulding which has a thermoplastic base moulding and a transparent surface layer located thereon comprising a transparent plastic formed by reactive polymerisation of at least two flowable components, where the thermoplastic base moulding and the transparent surface layer have an interface with one another which is formed by a thermoplastic film pigmented with flake-form effect pigments which has a film surface which faces the transparent surface of the polymeric moulding and has a three-dimensional pattern comprising bumps and/or pits, which is virtually enhanced by alignment of the flake-form effect pigments parallel to the bumps and/or pits in the thermoplastic film and is visible through the transparent surface layer, produced by a process according to claim 1.

11. Polymeric moulding according to claim 10, characterised in that the thermoplastic base moulding has a body which comprises particulate and/or soluble colourants.

12. Polymeric moulding according to claim 11, characterised in that the body is transparent, translucent or opaque.

13. A method comprising incorporating a polymeric moulding according to claim 10 as decorative and/or the labelling element or part of durable consumer goods.

14. A method according to claim 13, characterised in that the durable consumer goods are packaging, products in the electrical and electronics industry, domestic appliances, furniture, clothing, bags, shoes, sports articles, vehicles or vehicle parts.
